(19) United States
(12) Patent Application Publication
(10) Pub. No.: US 2015/0242767 A1
(43) Pub. Date: Aug. 27, 2015

(54) AERIAL VIEW, WEB-BASED TRIP PLANNING TECHNIQUES USING GEOTAGGED VIDEO AND IMAGES SYNCD TO A MAP

(71) Applicants: ACHILLEFS CHATZINIKOS, ATHENS (GR); EVANGELOS KASSIMATIS, STAMATA (GR)

(72) Inventors: ACHILLEFS CHATZINIKOS, ATHENS (GR); EVANGELOS KASSIMATIS, STAMATA (GR)

(21) Appl. No.: 14/633,115

(22) Filed: Feb. 26, 2015

Related U.S. Application Data
(60) Provisional application No. 61/945,067, filed on Feb. 26, 2014.

(51) Int. Cl. G06Q 10/02; G06T 13/80; G06F 3/0484

(52) U.S. Cl. CPC G06Q 10/02; G06F 3/04842; G06T 13/80; G06T 2200/24

(57) ABSTRACT

The present disclosure describes techniques for aerial view, web-based trip planning using geotagged video and images sync'd to a map. The process includes identifying a target travel area of interest in relation to a map selected by a travel planner, or by selection or search of a desired destination by the travel planner. A selection by a travel planner to a point on the map is then identified and an aerially taken video corresponding to the point on the map is retrieved. After this, a frame in the video, other than the beginning of the video, which has a geotag that is a closest match to the point on the map is identified. In response to this identification, a video player is launched to play the video from the point in the video corresponding to the identified frame. When at a point in time a selection to switch to image mode is identified, an aerially taken geotagged image substantially matching the geotag of that video frame in the video playing at the time of the selection to switch to image mode is retrieved. Thereafter, the travel planner is switched to image mode where the aerially taken geotagged image is displayed.

### RELATED APPLICATIONS

This application claims the benefit of U.S. Provisional Application No. 61/945,067, filed on Feb. 26, 2014, entitled “WEB BASED CONTENT AGGREGATION AND DELIVERY SYSTEM”, commonly owned and assigned to the same assignee hereof.

### TECHNICAL FIELD

The present disclosure relates to techniques to facilitate easy trip planning by travelers and travel agent professionals.

### BACKGROUND

The World Wide Web has become a prevalent means for searching out information, especially in relation to planning a trip, vacation, or holiday. Points of interest, lodging, aesthetic appeal, travel costs, and climate are some of the aspects that potential tourists consider before undertaking a trip. Furthermore, companies that offer services such as hotels, sightseeing trips, restaurants, have an interest in advertising to a potential customer to increase their revenue.

Successful trip planning by travelers and travel agents using conventional methodologies has proven extremely onerous. To help traveler's in their decisions, and at same time promote their own offerings, hotels and the like travel destinations rely heavily on technology to showcase their surroundings.

Larger resorts, with hundreds, if not thousands of rooms, often compete aggressively for travelers. In fact, for many travelers, the ability to view the facilities up close is often a precondition to the decision on where to stay. For tourist destinations such as Greece, Italy, Spain, and other parts of the world, where travelers are seasonal and many hotels in fact close during the off-season, it is critical that the hotel operate to capacity when it does operate.

The use of video and photographs has proven extremely effective in showcasing properties. Many travel sites offer both video and images, but also map views to help a traveler in their travel planning.

There is a need for new techniques that can further enhance this travel planning experience for customers

### SUMMARY

The present disclosure describes a computer implemented web-based platform to aid in travel planning Techniques are described for providing a travel-planning friendly user interface (UI) with user-selection control for easily switching from geotagged video and still images taken aerially.

The process includes identifying a target travel area of interest in relation to a map selected by a travel planner, or by selection or search of a desired destination by the travel planner. A selection by a travel planner to a point on the map is then identified and an aerially taken video corresponding to the point on the map is retrieved. After this, a frame in the video, other than the beginning of the video, which has a geotag that is a closest match to the point on the map is identified. In response to this identification, a video player is launched to play the video from the point in the video corresponding to the identified frame. When at a point in time a selection to switch to image mode is identified, an aerially taken geotagged image substantially matching the geotag of that video frame in the video playing at the time of the selection to switch to image mode is retrieved. Thereafter, the travel planner is switched to image mode where the aerially taken geotagged image is displayed.

In an exemplary embodiment, as the video frames and or still images play in sequence, the current geolocation of the moving vehicle from where the media content was taken (in terms of geo-location) is displayed graphically on the map visual displayed on a separate portion of the screen. The map information may include a sliding zoom feature.

In another scenario, the map is adapted to include a hyperlink to one or more video streams comprising the video collection associated with a particular location. Each video stream is of predetermined length and may cover the same or different area of travel depending on the extent to which travel planners are likely to explore a fly-over area.

The platform includes a mechanism that facilitates replacing any one video stream without impacting any of the other video streams, as may be necessary, when a new hotel for example, has gone up in the area associated with the updated video stream.

In a preferred embodiment, the aerial video and photography are taken along the coastlines from a helicopter, airship, unmanned aerial vehicle, or the like,

In another aspect, aerially taken images are specially taken photographs using a trained eye.

In another aspect, multiple photographs are shown in image view taken by multiple cameras simultaneously and geotagged to the same frame or set of frames of the corresponding video sequence.

In yet another aspect, the still images include optional tags (hyperlinks) to websites of sponsored hotels, places of interest, promotional info, and/or targeted advertising.

In another aspect, for travel planning purposes, the video streams may be tagged as shared and forwarded to third party. The third party may be provided with a plug-in or other functionality enabling the user to view the video stream as part of a browser with functionality similar to that of the platform, and to also switch to image view as when logged on to the travel planning server. In another approach, the recipient is required to link to the platform where he/she is taken to the travel planning platform directly.

In yet another aspect, the trip planning is performed by a travel agent professional. The travel agent may provide a customer with a single destination view, with multiple alternative destination views to consider, or with a pre-planned package comprised of different destinations. The customer simply clicks on the links where he/she can experience visually a new way by which to capture the surrounding aesthetics of places one would hope to visit, and in an easy to visualize way, quickly grasp from multiple angles, different digital visual content.

In one approach, the images are taken, by a trained photographer, at the same time the video is taken so as to provide a timestamp reference between the two forms of digital content. In another approach, each frame of video is individually geotagged in the same way the still images are geotagged, and the platform includes a mechanism for synchronizing the video data in a database of different destinations to the corresponding still images based on geotag information. Given this latter approach, the images may be taken at the same time, in the same manner, or at a different time and different manner.

In yet another approach, the platform includes same screen accessible links which provide information about an area being currently viewed, such as weather, history, currency, crime, advertising opportunities, local hospitals, popular bars, special hotel or attraction discounts, special package arrangements by local travel agents, and the like.

In yet another scenario, the map information is displayed in either or both 2D and 3D perspective, and the map rotated in sync with the direction of travel of the vehicle from which the video is taken to provide a positional orientation of the vehicle in relation to the map. GPS positioning information may also be provided to record the height/depth of the aerial video recording and to provide a visual of this information in the form of a graphic or by zooming the map portion of the screen in and out of the page as a function of dive, speed and orientation conditions of the aerial recording vehicle.

In another scenario the content is collected, in part using unmanned vehicles, with video and still image content being taken and/or controller remotely by automatic pilot.

The summary is neither intended nor should it be construed as being representative of the full extent and scope of the present disclosure, which these and additional aspects will become more readily apparent from the detailed description, particularly when taken together with the appended drawings.

### BRIEF DESCRIPTION OF THE DRAWINGS

FIG. 1 shows a web based content aggregation and delivery system in accordance with the present invention.

FIG. 2 shows a display user interface (UI) of the TRIPINVIEW™ system in accordance with a preferred embodiment.

FIG. 3 shows a display user interface (UI) of the TRIPINVIEW system in accordance with an alternate embodiment.

FIG. 4 is a high level operational flow diagram in accordance with a preferred embodiment.

FIG. 5 is a high level operational flow diagram 500 in accordance with an alternate embodiment.

FIGS. 6-24 are screen shots associated with a related alternative UI embodiment.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

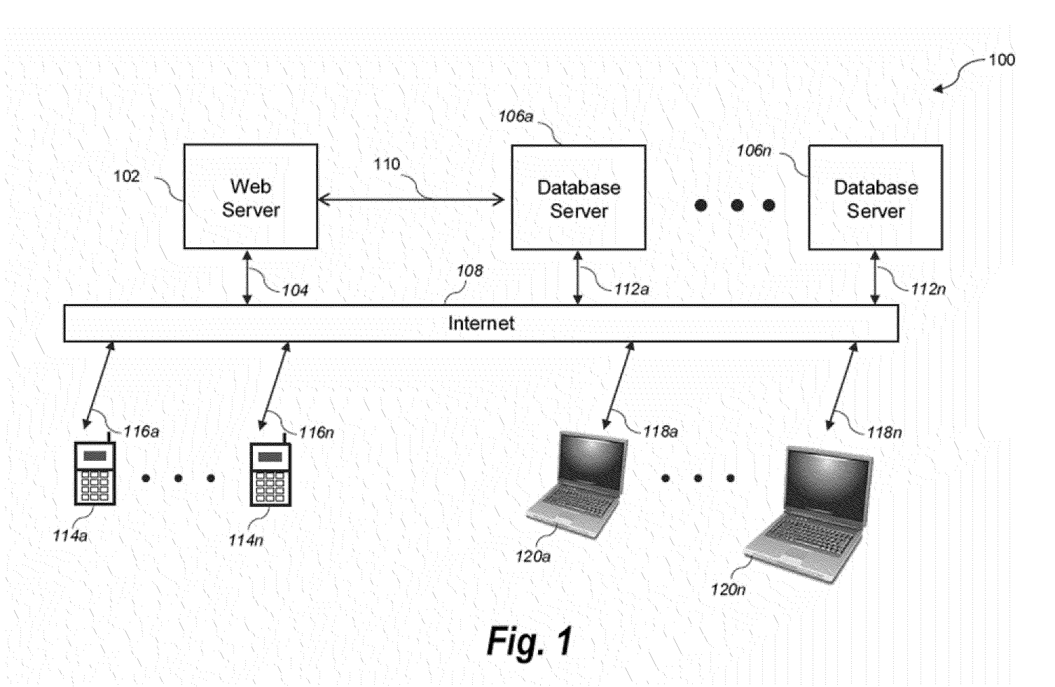

FIG. 1 shows a web based content aggregation and delivery system 100 in accordance with the present invention. Web server 102 is coupled to Internet 108 through connection 104. The components that comprise Web server 102 and connection 104 are well known in the art. Web server 102 delivers content through the World Wide Web to at least one of portable computing devices 114a, . . . , 114n and non-portable computing devices 120a, . . . , 120n. Portable computing devices 114a, . . . , 114n and non-portable computing devices 120a, . . . , 120n may also refer to “client side” interactions as is known in the art. Connection methods 116a, . . . , 116n which couple portable computing devices 114a, . . . , 114n to Internet 108 may be wireless or wired. Examples of wireless connection methods 116a, . . . , 116n are cellular connections implementing wireless standards such as LTE or 3GPP and other wireless connections such as Bluetooth and Wifi as is known in the art. Examples of wired connection methods 116a, . . . , 116n are universal serial bus (USB). Similarly, connection methods 118a, . . . , 118n may be wireless or wired. Connection methods 118a, . . . , 118n may use additional technologies, for example, Ethernet, as is known in the art.

Web based content aggregation and delivery system 100 further comprises database servers 106a, . . . , 106n which are coupled to Internet 108 via connection methods 112a, . . . , 112n as is known in the art. The database servers may be co-located in the same physical location as web server 102 or may be remotely located. In one aspect of the present invention, database server 106a contains a database of digital content comprising at least one of text, sound, photographs, video, and map data. For map data, it is convenient to use database servers from third parties such as Google Maps or Navteq, as is known in the art. In another aspect, web server 102 may be coupled to database servers 106a, . . . , 106n via alternate network connection 110. Alternate connection 110 may be used when database server 106a is co-located with web server 102. An example of alternate connection 110 is an Ethernet connection through a router.

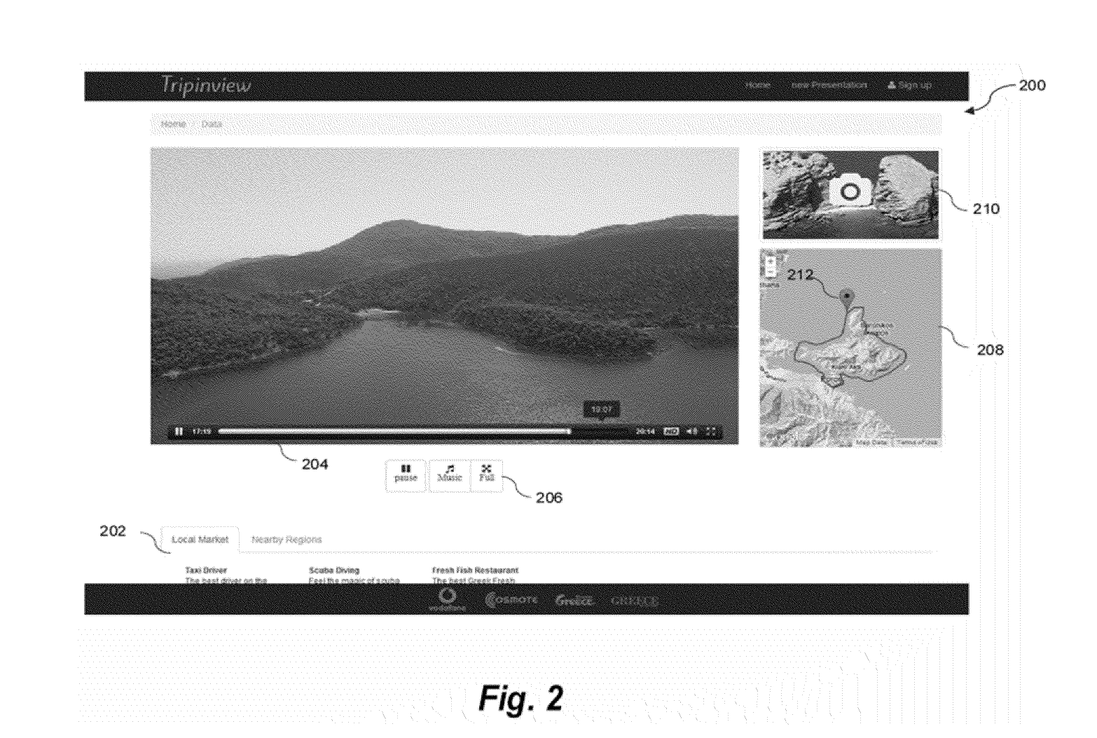

FIG. 2 shows a display user interface (UI) of web-based content aggregation and delivery system “TRIPINVIEW” in accordance with an exemplary embodiment.

The trade name “TRIPVIEW” is a commercial instantiation and demonstration of web based content aggregation and delivery system 100.

In one aspect, video playback display 204 includes a video playback bar which may represent time or may represent linear distance. Control panel 206 is used to further control video playback display 204. While video is being played, map frame 208 is displayed along with map pointer 102. Map pointer 102 is located on map frame 208 at the approximate geolocation corresponding to where video displayed on video playback display 204 was captured. Photograph 210 displays still photographs corresponding to the approximate geolocation of map pointer 102 and video. Text and advertising 202 is displayed and synchronized with the geolocation of map pointer 212, video playback display 204, and photograph 210. When the playback of video has proceeded a pre-determined time or distance or the video playback bar has been advanced, photograph 210 and map pointer 212 are updated to reflect the synchronization in time and geolocation of updated video playback display 204.

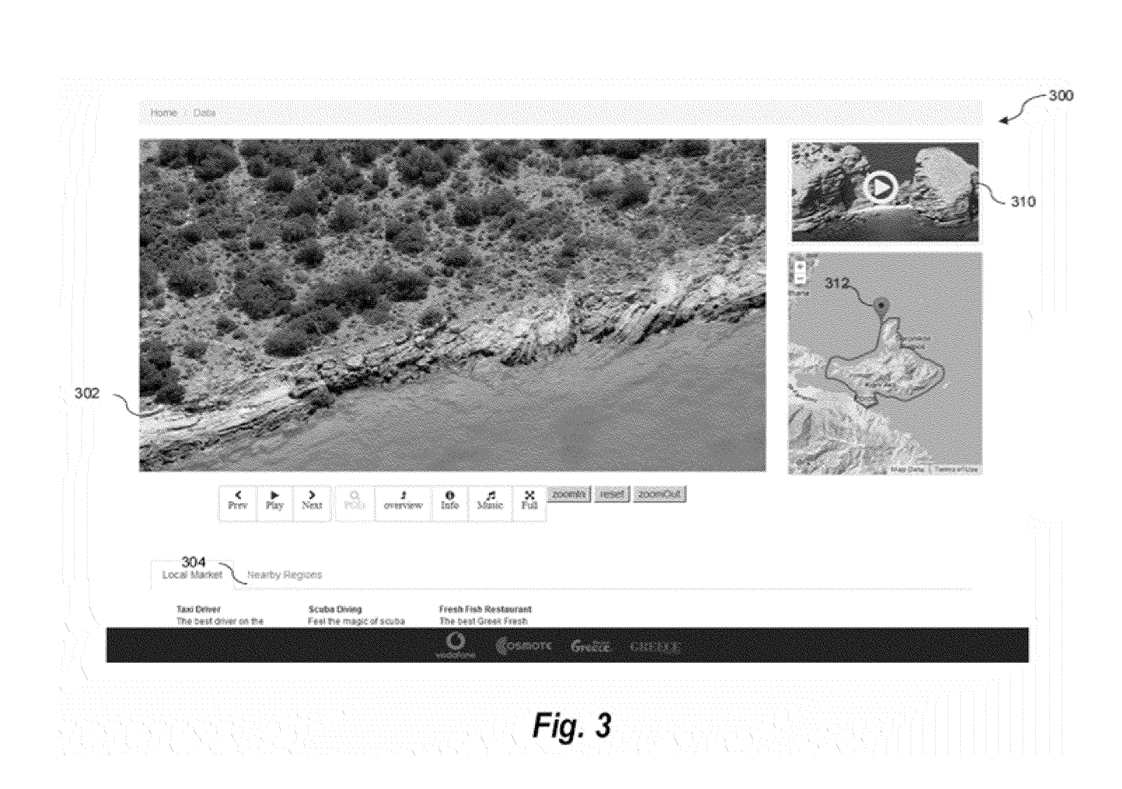

FIG. 3 shows a display user interface (UI) 300 of the TRIPVIEW system in accordance with an alternate embodiment. The alternate embodiment is similar to the preferred embodiment, wherein photograph 302 is prominently displayed and video playback display 310 is not prominent. In one aspect, video playback display 310 plays a loop of video, wherein the start of the loop is fixed at a point relative to the geolocation of video playback display 310 and map pointer 312. If map pointer 312 is moved, the corresponding video playback display 310 and photograph 302 are updated to reflect the new position. Text and advertisement 304 is updated to correspond to the updated geolocation as determined by moved map pointer 312.

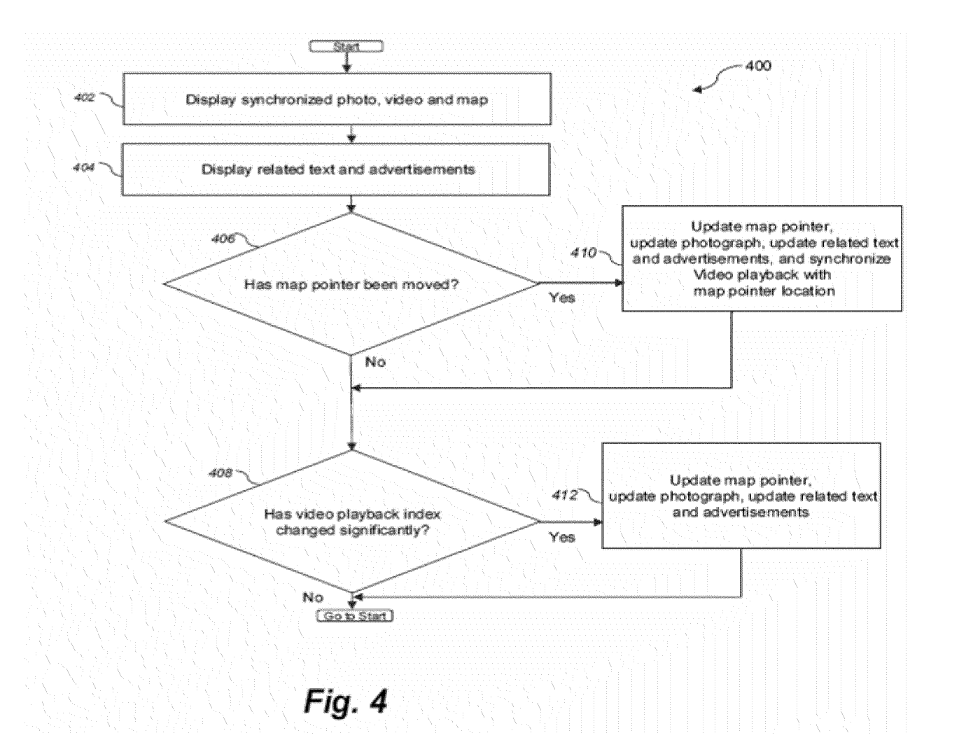

FIG. 4 is a high level operational flow diagram 400 in accordance with a preferred embodiment. Block 402 displays synchronized photo 210, video playback display 204, and map pointer 212. Flow then transfers to block 404 wherein text and advertisements 202 are displayed that correspond to the synchronized geolocation of synchronized photo 210, video playback display 204, and map pointer 212. Block 406 checks if map pointer 212 has been moved. If it has been moved (Yes), then block 410 updates map pointer 212 to the new geolocation, and photograph 210, text and advertisements 202, and video playback display 204 are updated corresponding to the new geolocation and flow moves to block 408. If map pointer 212 has not been moved (No), then flow moves to block 408. Block 408 checks to see if the video playback has proceeded a pre-determined time or distance or the video playback bar has been advanced. If it has (yes) then photograph 210 and map pointer 212 are updated in block 412 to reflect the synchronization in time and geolocation of updated video playback display 204. Video playback then resumes and moves to start.

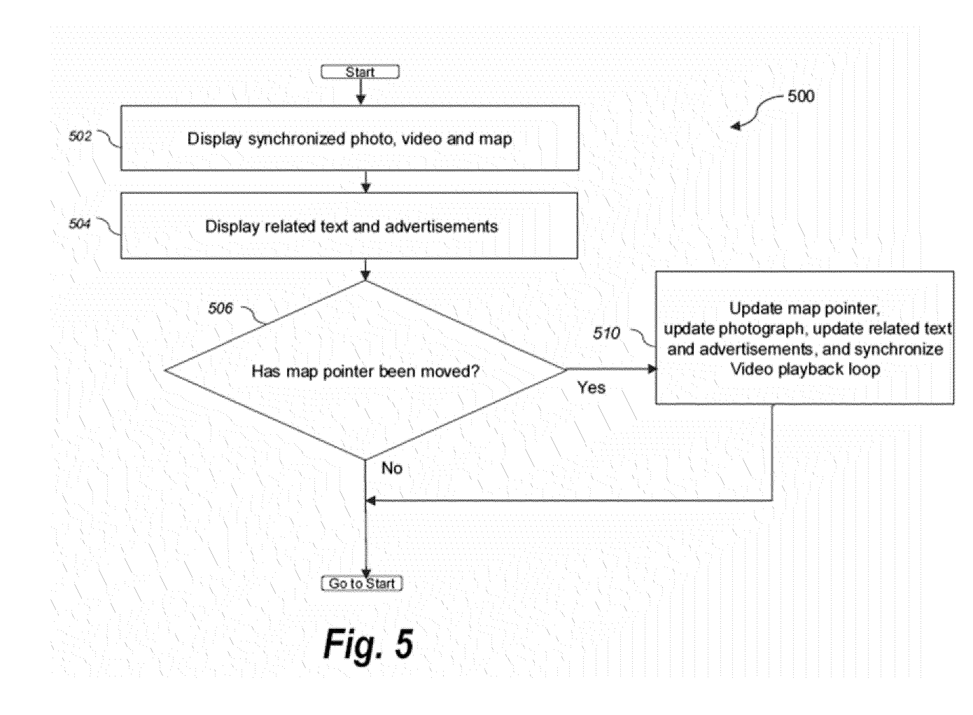

FIG. 5 is a high level operational flow diagram 500 in accordance with an alternate embodiment. Block 402 displays synchronized photo 302, video playback display 310, and map pointer 312. Flow then transfers to block 504 wherein text and advertisements 304 are displayed that correspond to the synchronized geolocation of synchronized photo 302, video playback display 310, and map pointer 312. Block 506 checks if map pointer 312 has been moved. If it has been moved (Yes), then block 510 updates map pointer 312 to the new geolocation, and photograph 302, text and advertisements 304, and video playback display 310 are updated corresponding to the new geolocation. Video playback display 310 displays video in a loop of finite duration wherein the start of the loop is fixed at a point relative to the geolocation of video playback display 310 and map pointer 312 and flow moves to start. If map pointer 312 has not been moved (No), then flow moves to start.

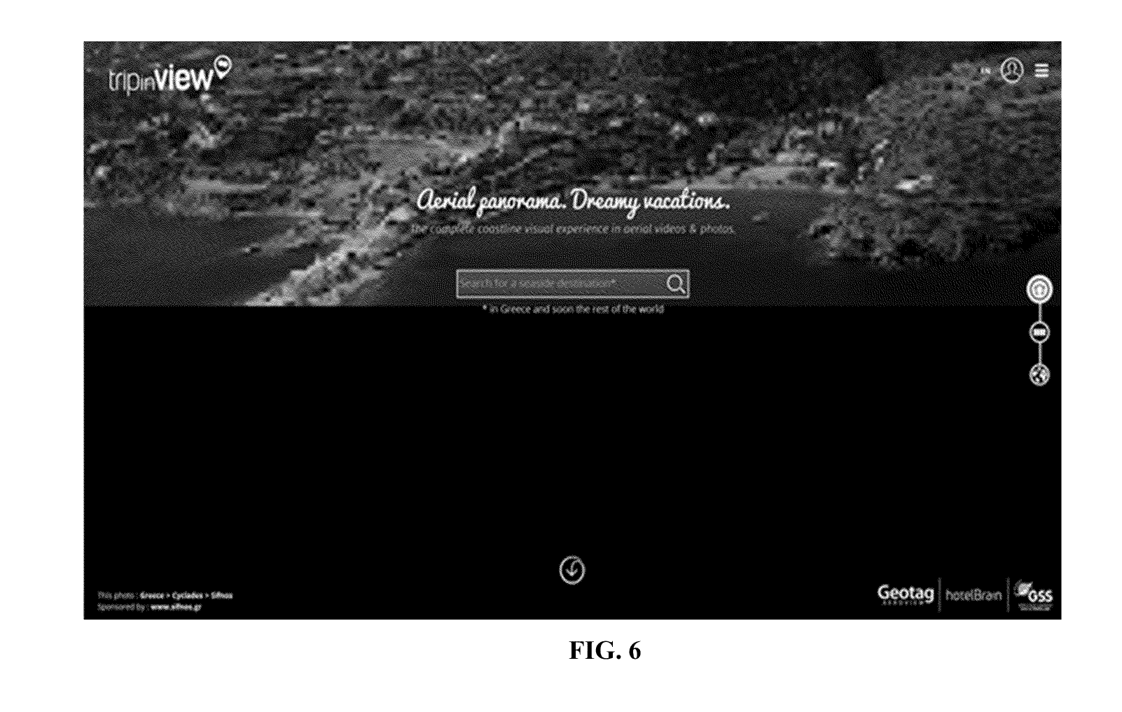

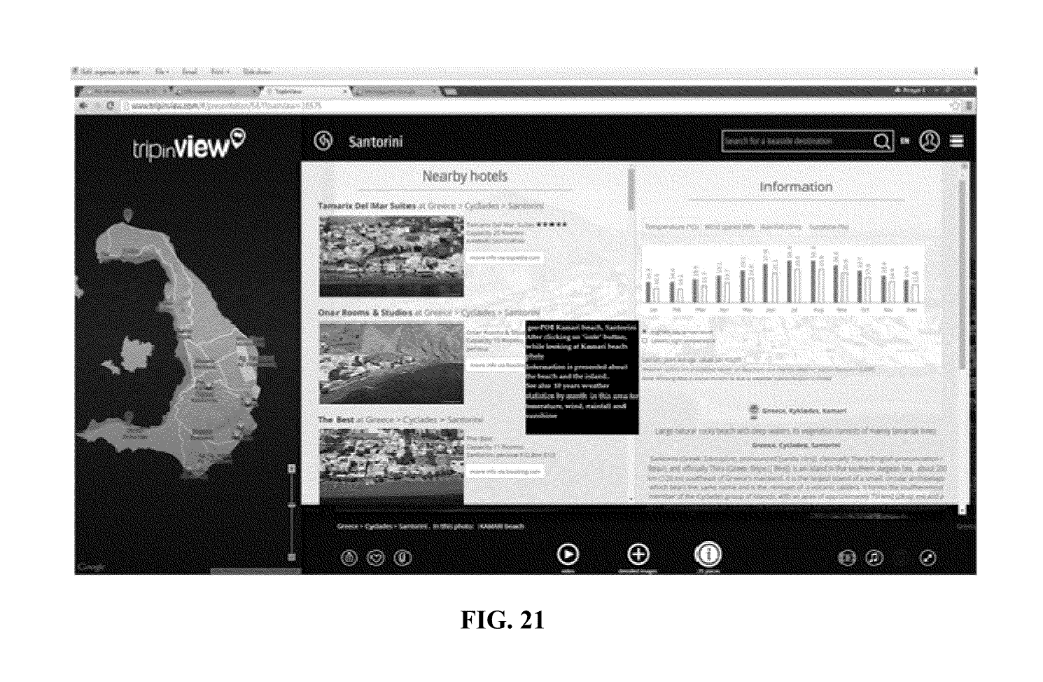

FIGS. 6-24 are screen shots associated with a related alternative UI embodiment.

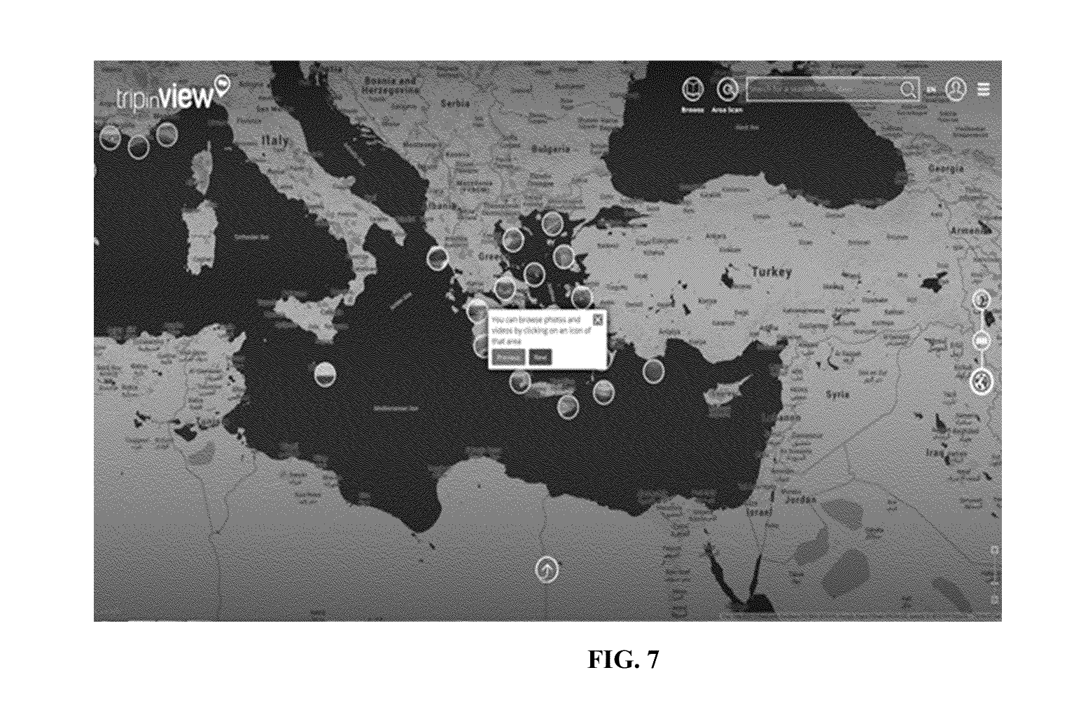

FIG. 6 shows the HOME screen of the web-based travel planning platform TRIPINVIEW in accordance with an exemplary embodiment. Here, a visitor to the site is presented with the screen shown and invited to search for a travel destination. The arrow just below the search field allows the visitor to navigate to the screen shown in FIG. 7.

This latter screen is a full or partial map of the globe with links, preferably, to popular vacation “coastal” destinations. Just as with Google Maps and other web-based mapping tools, a visitor is able to move around the map to locations to the left, right, top or bottom, and/or zoom about to arrive at a desired map position and map orientation. A pop-up is presented to remind the visitor that it can click to preselected travel destination positions to begin location surfing and trip planning.

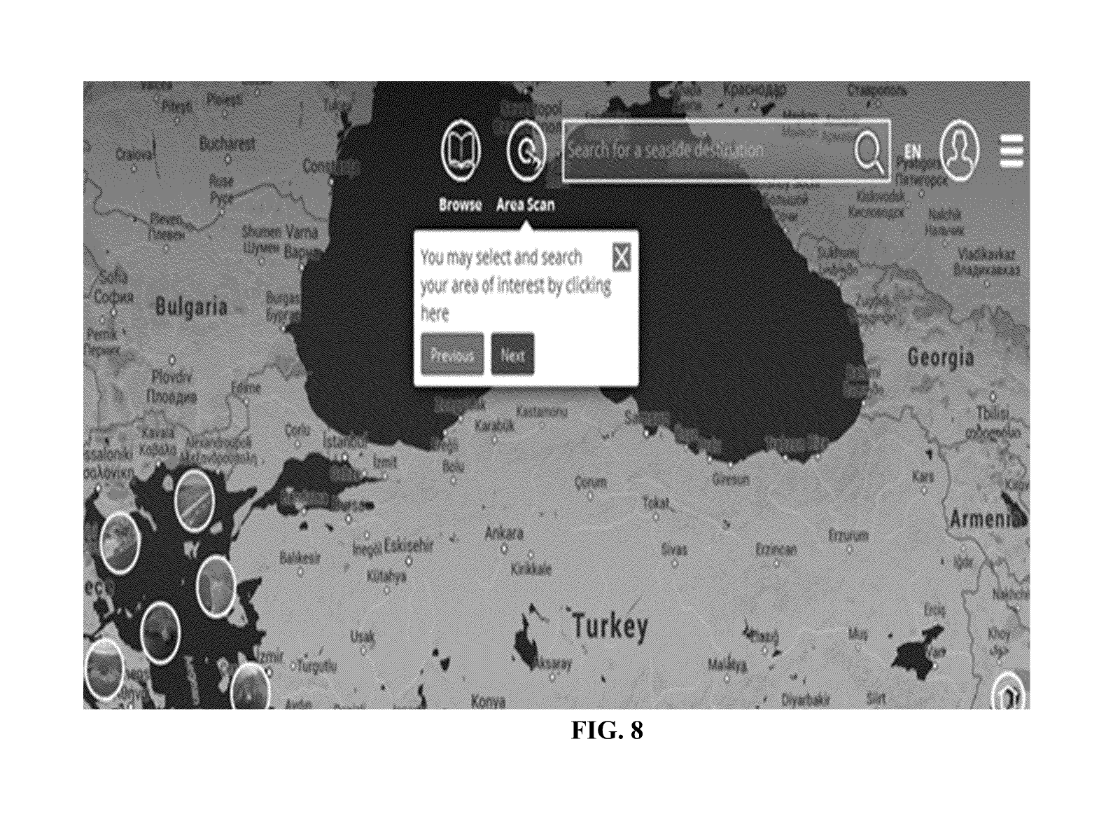

FIG. 8 illustrates that it is possible to also have the platform make suggestions for popular travel destinations to view video and images for based on a current map location.

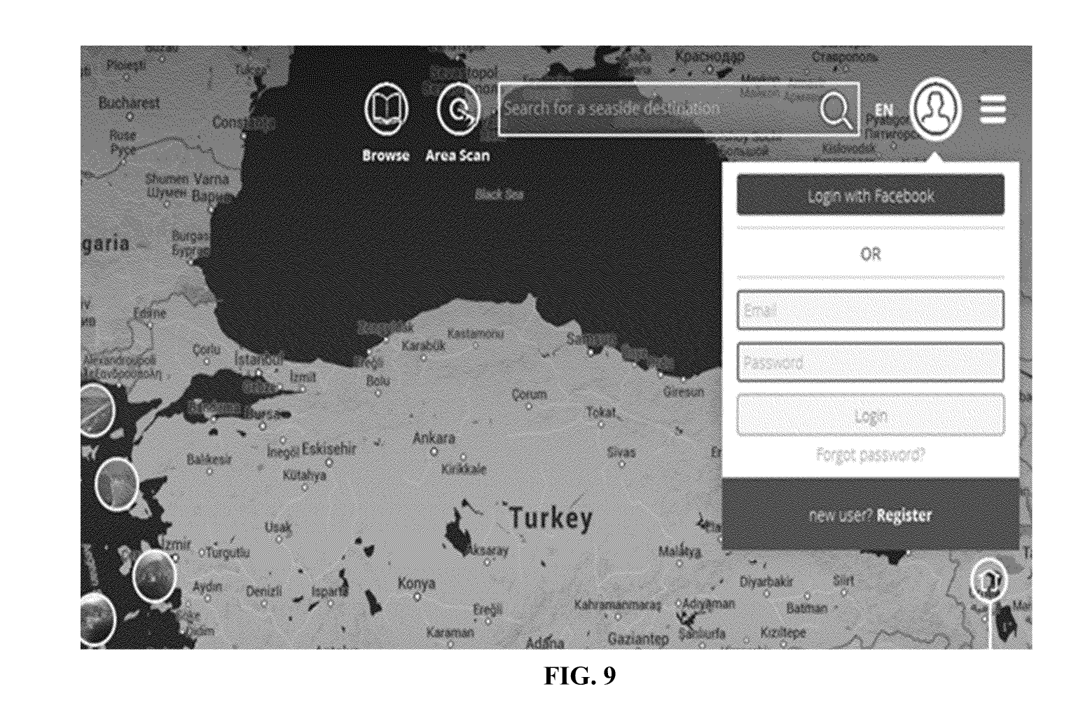

In order to make full use of the travel planning services available by the platform, a visitor may be invited to log in automatically, or in response to a selection to perform member only function, such as uploading of an image or selected video for later use. This is shown in FIG. 9.

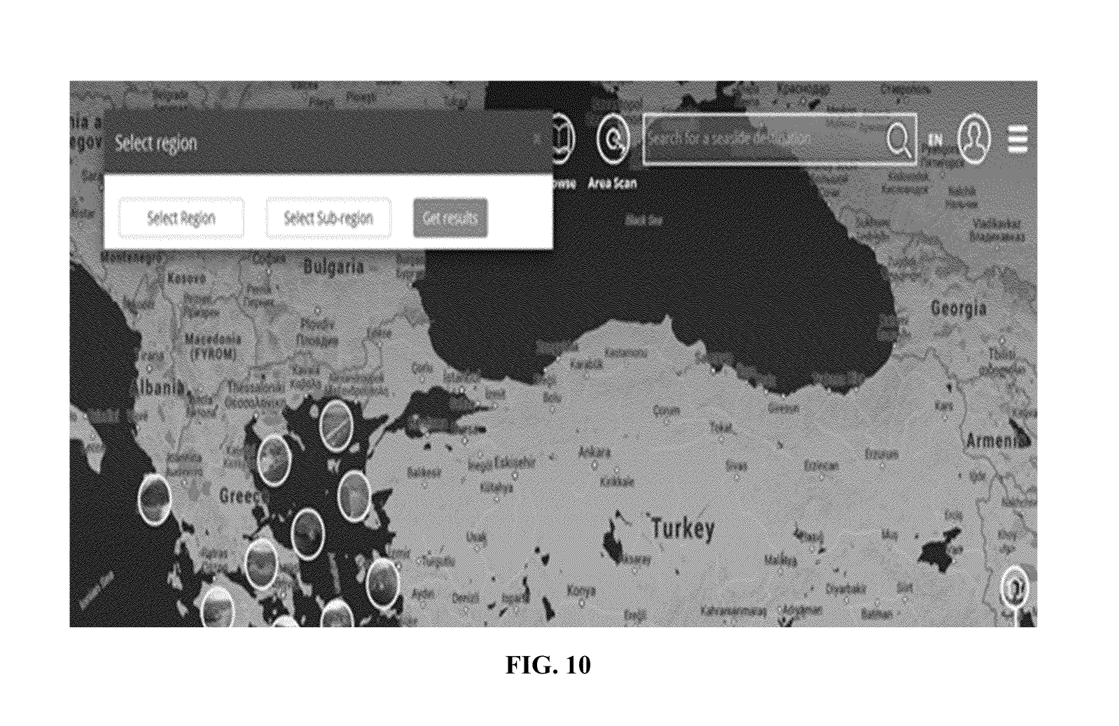

Another available feature, shown in FIG. 10, is the ability to select a specific region and/or sub-region to browse for travel destinations.

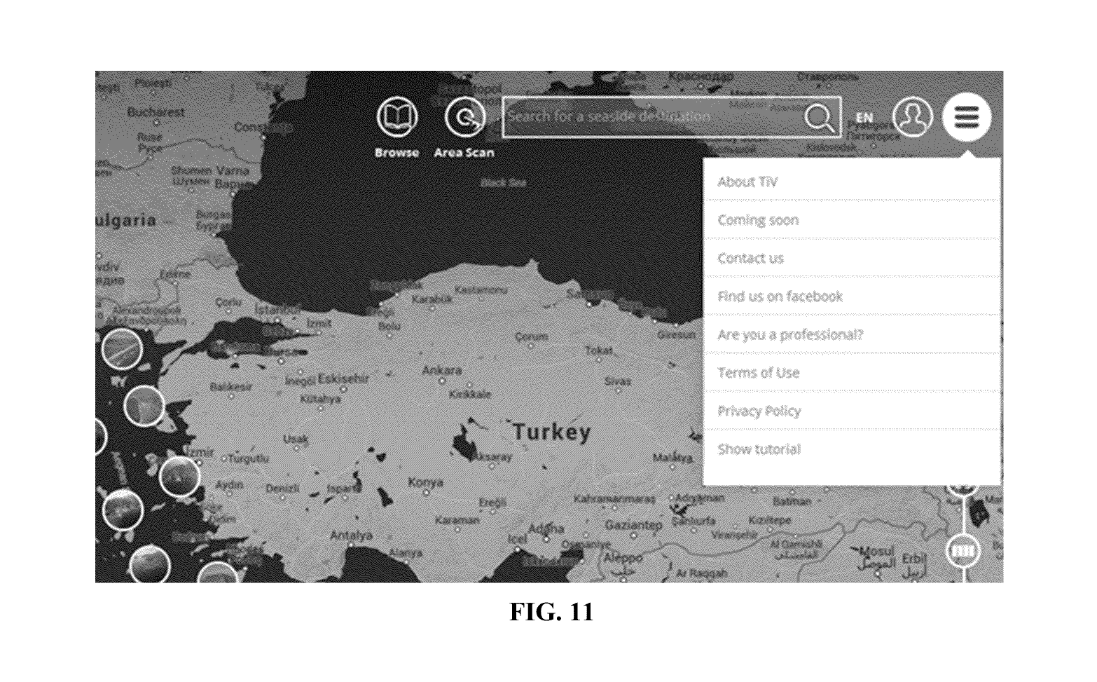

A pull-down menu, as shown in FIG. 11, provides how to and other useful information access.

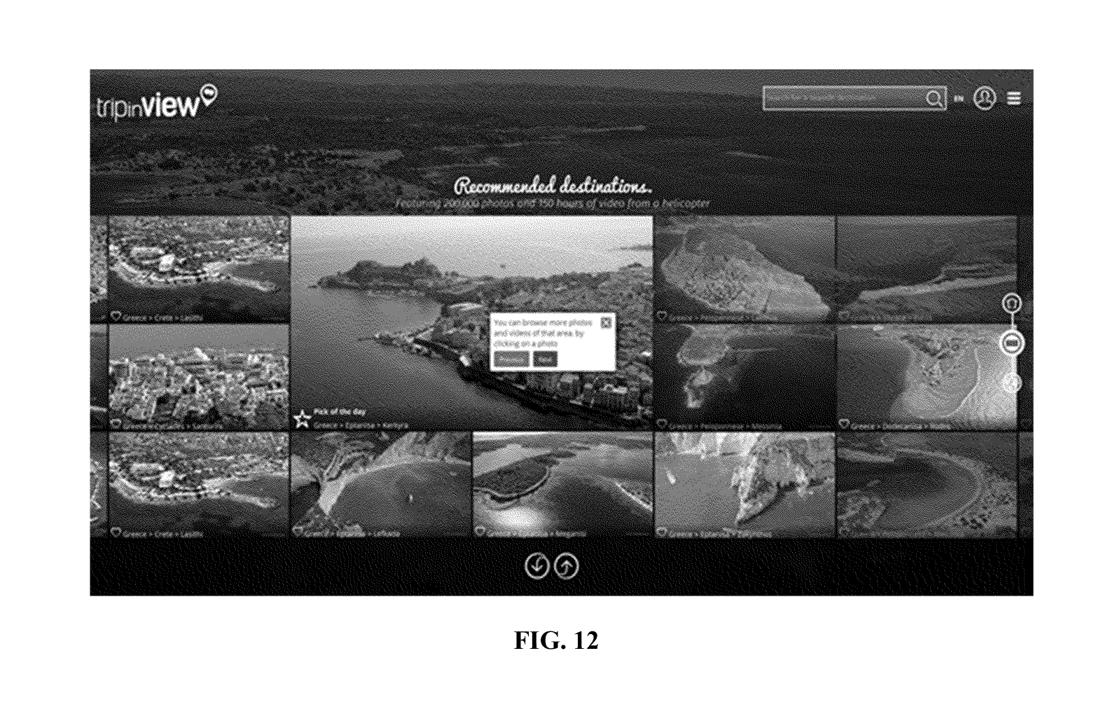

In another scenario, in addition to clicking on a position on a map, doing an area scan, or browsing by region, it is optionally also possible to navigate the arrows to arrive at a further screen similar to that shown in FIG. 12. A collage of different travel destinations is presented together with the ability to slide sideways in the left and right directions to reveal additional sets of collaged destinations. In one scenario, the destinations may be favorite destinations as determined by member provided ratings, and/or selections of popular travel destinations based on a given time of the year, season, holiday period, major event, etc.

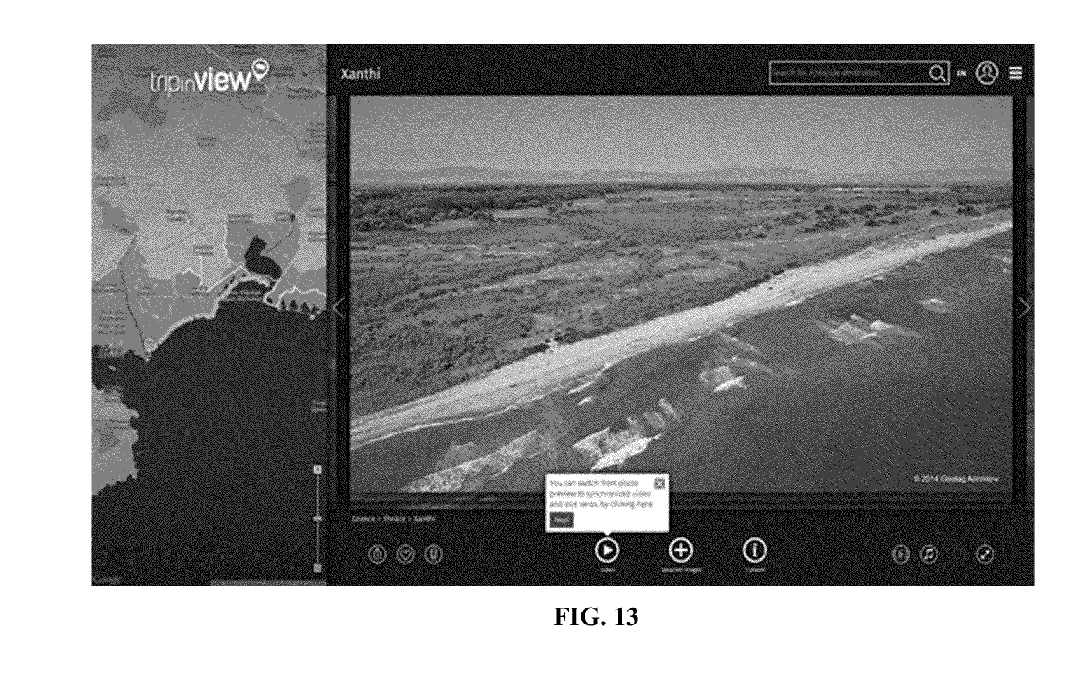

FIG. 13 is an example screenshot of what might be displayed to a user after their having selected a travel destination from a list. The circled, right-pointing arrow is a mouse- or touch-screen selectable icon that allows the user to switch from image mode to video mode. In video mode, a routine makes a call to the corresponding geotagged video that corresponds to the currently displayed picture. As with any video player, a video browser is activated together with hot keys preferably at the bottom edge of the displayed video to enable, among other things, the user being able to start and stop at will, and also control such functions as speed, brightness, contrast and other similar functionalities.

For each video segment that is activated there is a point (or, depending on resolution, a curve) the map corresponding to the relative physical geotagged position of where the video was taken in relation to the map.

A person using the platform to experience different travel destinations in order to plan a trip for themselves or someone else, is allowed to switch between geotagged relevant video and image modes to enjoy an experience very similar to what it might feel like if they were flying over the destination, and had the ability to turn one's head and capture image memories from humanly desirable perspectives.

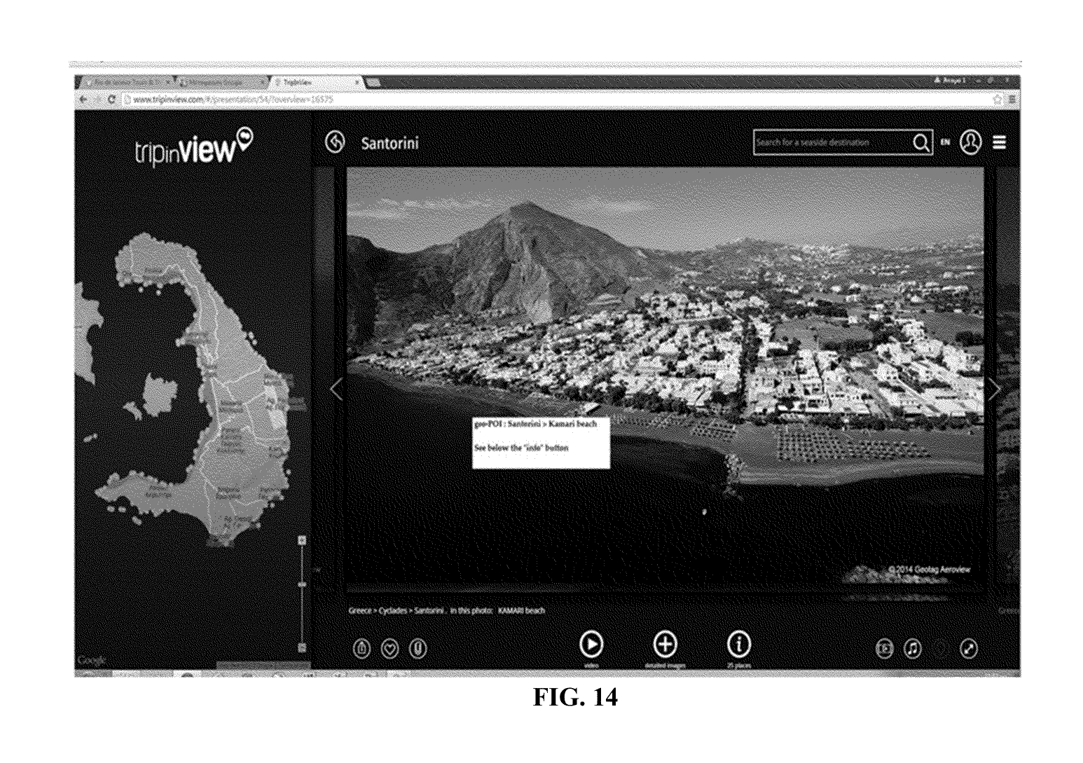

FIG. 14 is a screen shot of a different travel destination than the one shown in FIG. 13. As in FIG. 13, the default screen is image mode. Arrows to the left and right of an image allow the travel planner to sequence through time-sequenced geotagged pictures very much like a movie, except the images are taken from different perspectives, as opposed to a fixed video camera orientated in a fixed position about the direction of flight.

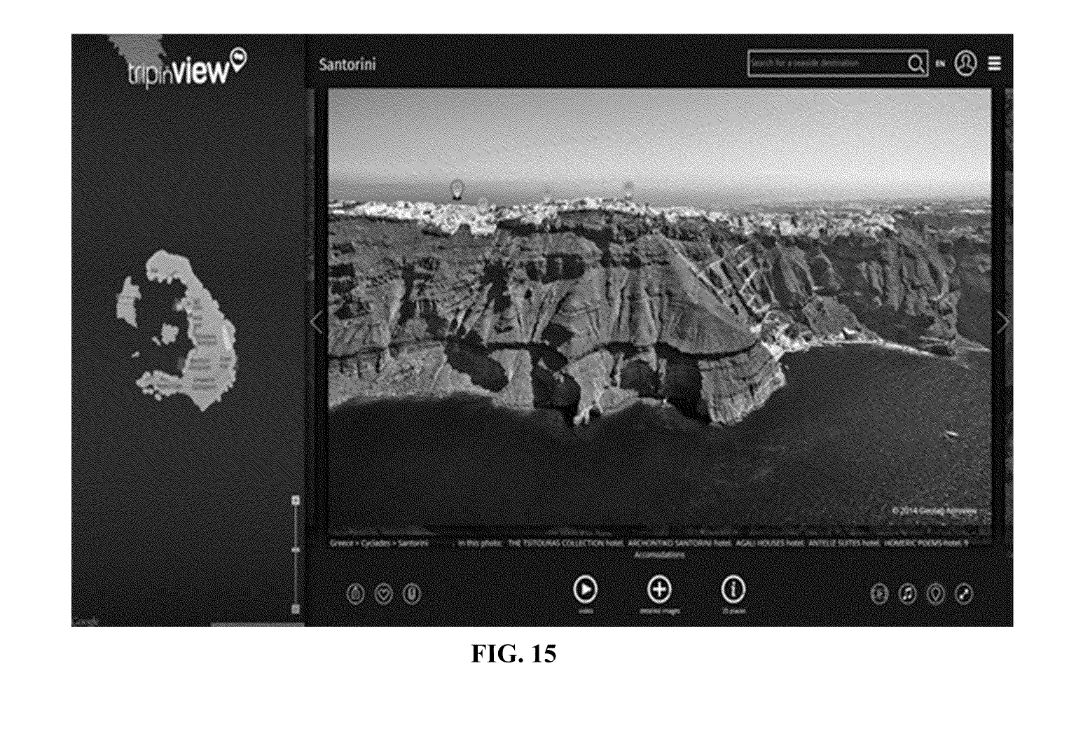

In FIG. 15, we see a further downstream image from that in FIG. 14. Here, the travel planner has zoomed out on the map to have a better sense of where the video or picture is being taken from. Looking at the image itself, we see a couple of locations on the image having been singled out. The locations singled-out could be hotels offering discounts, hotels that subscribe or are members of the platform entitling them to promotional advertising space on the images, it could be to communicate to the visitor that additionally electronic information is available on those specific locations/hotels, or any other number of reasons.

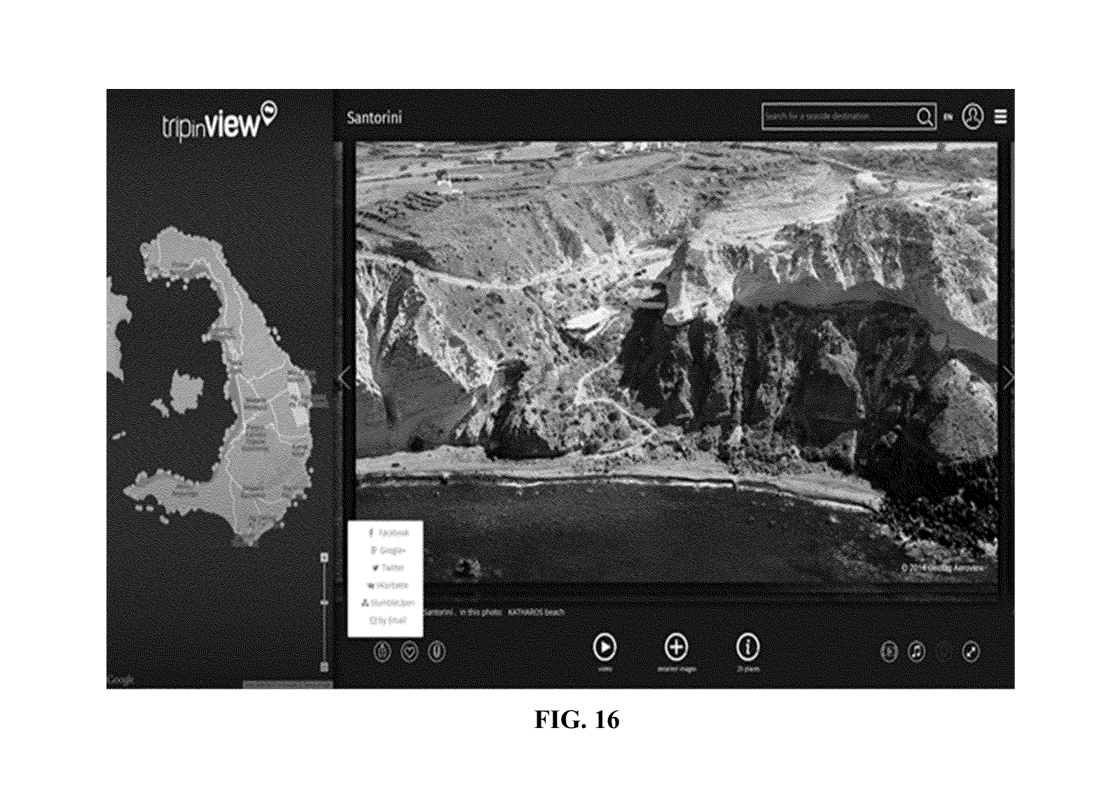

In FIG. 16, we see that by hovering over or clicking on the icon at the bottom left of the video/image viewing portion of the UI, a pop-up selection menu is presented. From here, it is possible to share the image and/or video currently being viewed. This feature makes it possible to direct a travel partner to go check out the travel destination, hotel or other information being displayed there. A travel agent may send a client to the site (by sharing) to introduce them to the destination and hopefully get them to work with the travel agent to book flight and hotel accommodations.

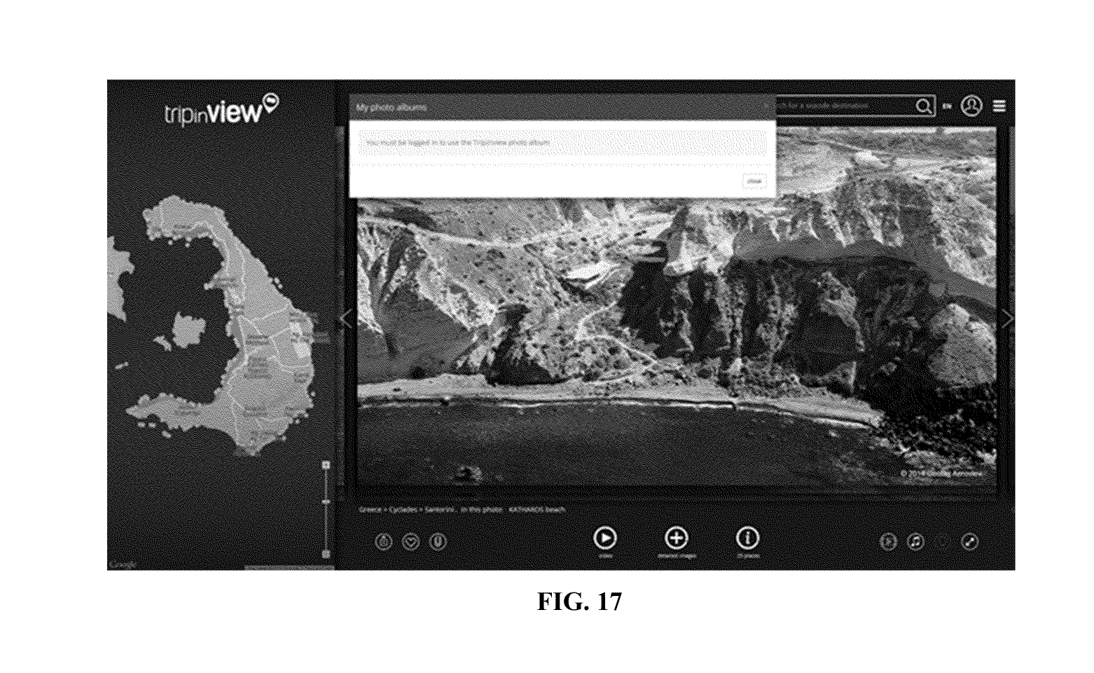

In addition to sharing photos with third parties, which may be available even to non-members, visitors may also store the images of one or more destinations in a member personal album. In FIG. 17, a visitor attempts to upload an image to an album who has not yet logged on. The pop-up reminds the visitor to first log on.

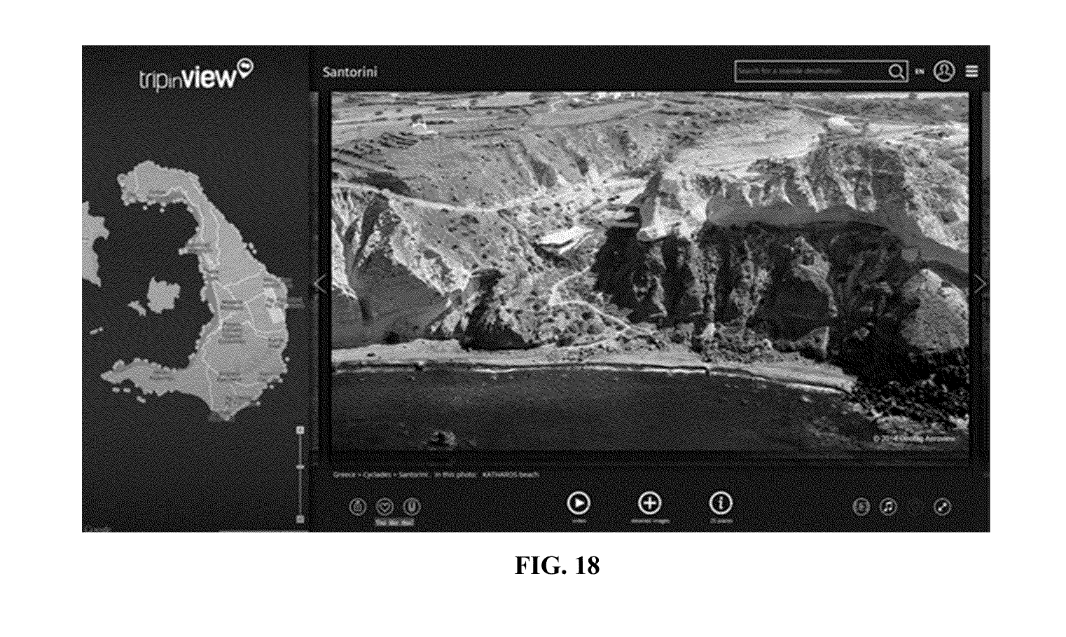

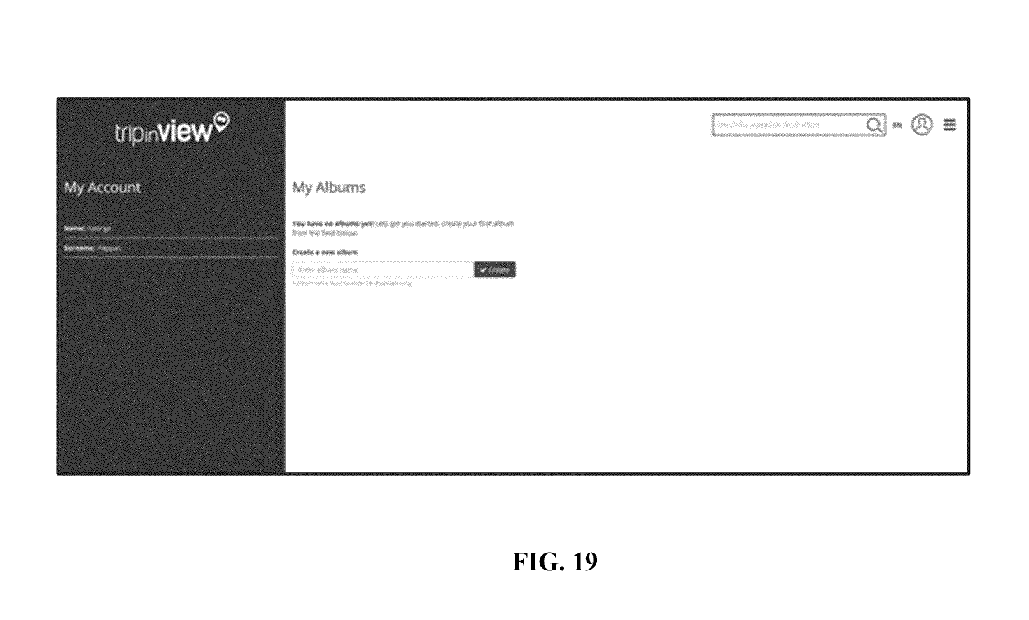

Once logged on, the platform goes back to the image screen the visitor was at prior to attempting to log on and waits for further action (see FIG. 18). In FIG. 19, the visitor is now logged on and has again attempted to upload an image in response to which this screen is presented asking the member to identify to which album it wishes the pictures to be stored.

It should be appreciated that the album can be populated with personal pictures as well. In this regard, by uploading a single picture into a TRIPINVIEW album, because this picture is geo-tagged, it can function as an identifier for a routine to look for other geo-location relevant, geotagged pictures taken during an actual trip. A routine simply has to scan one's computer for pictures taken in the vicinity of a picture placed in an album, and then cause those pictures to be moved/copied/uploaded into the same folder. In this regard, TRIPINVIEW can easily also function as an independent picture management and sorting tool based on geo-tag data built into pictures taken with a GPS-enabled phone.

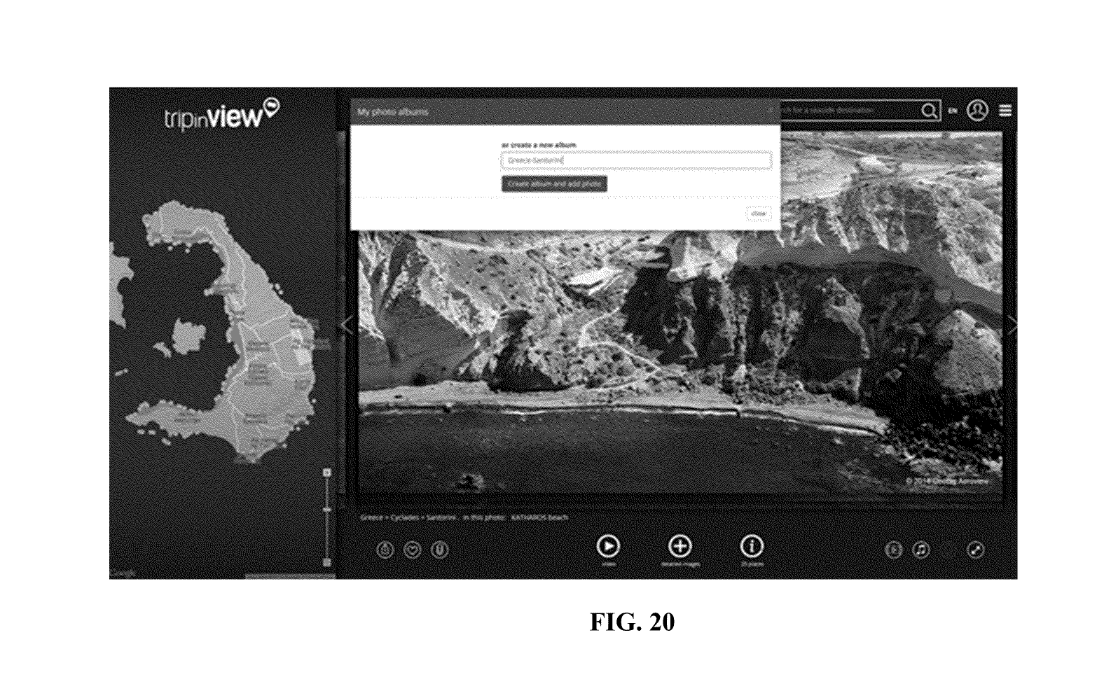

In FIG. 20, in response to a request to save another picture in an album, a pop-up window is presented to confirm that this picture should also go in the same album.

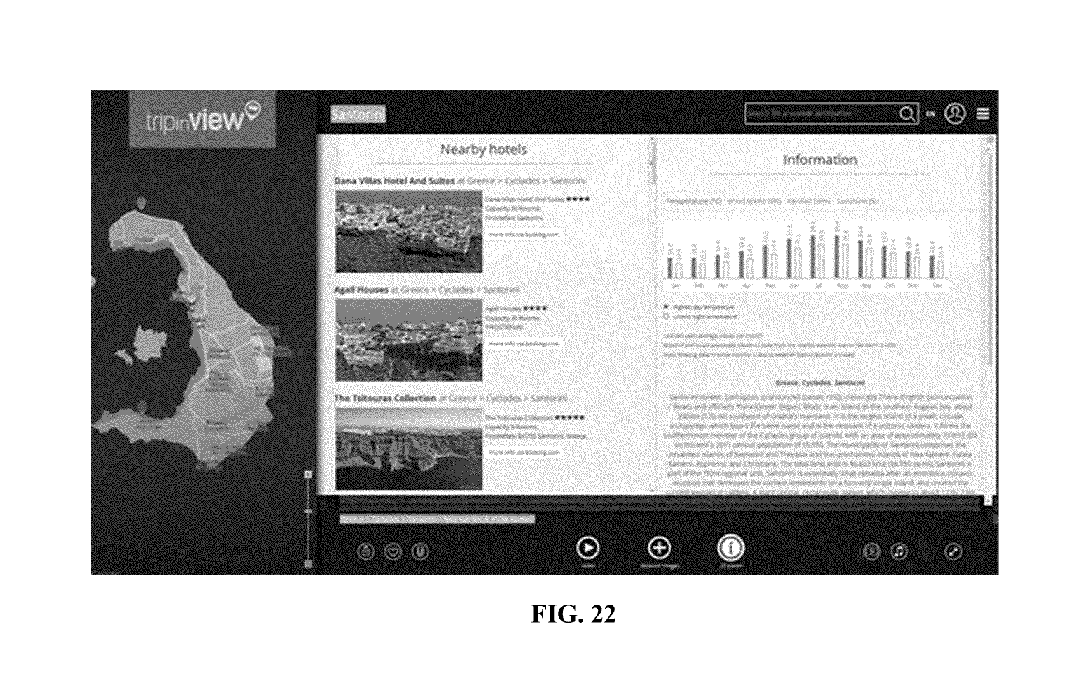

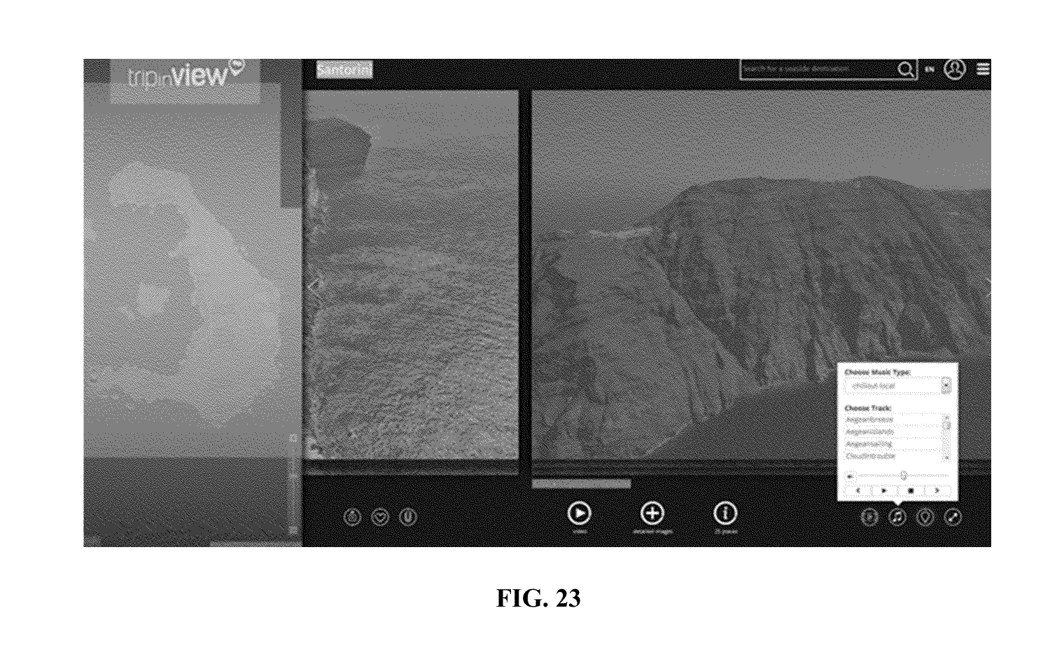

FIGS. 22 and 23 are examples of additional information that may be presented when clicking the circled (i), which stands for information, at the bottom of the screen. The newly-presented information screen is best suited to reveal sponsored hotels, for example, which can act as a substantial source of revenue for an otherwise free service.

FIG. 23 shows what a visitor might see when in image mode while images are in transition. FIG. 23 also shows a pop-up window triggered by clicking or hovering on the button marked with a musical note. This pop-up window assists the user to select particular music or melodies to be played when watching a video stream or an image sequence stream, or both. The melodies could be automatically selected to play songs or melodies associated with the travel destination to place the travel planner in the right state of mind, and hopefully him or her to select, through the power of music, what best destination to select fort the next trip.

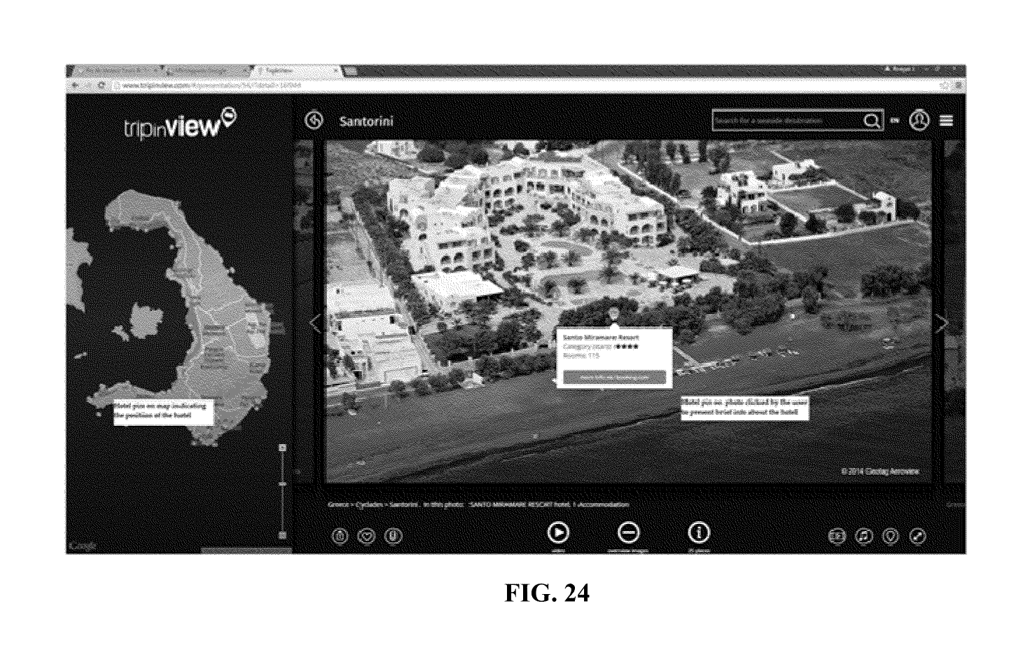

FIG. 24 is a close up image of a resort hotel located on a shore line. A link to the hotel itself is available directly from the image, but also any promotional or other information about the location that may be desirable to present could be presented. This in fact is very valuable as it creates an excellent, content-relevant form of targeted advertising not previously possible.

It should be noted that one skilled in the art would identify that some of the operational flow diagram blocks may be completed in an alternate order or simultaneously. For example, blocks 502 and 504 may be performed simultaneously or in a different sequence with the same resulting user interface (UI) experience. As system 100 implementation would be implemented on high speed computing devices, observed latency to an observer may seem to be negligible and display updates may appear simultaneously.

In the context of promoting tourism in the present invention, that geotagged video and photographs may be acquired through aerial photography such as with a helicopter or airplane. Video and photographs may be simultaneously captured one or more devices, with one or more synchronization and geotagging mechanisms as is known in the art. Metadata databases of the digital content is generated and indexed as is known in the art. Content that is displayed in the present invention may showcase items such as coastal beauty, beaches, ports, marinas, gulfs, bays, capes, islands, riffs, light houses, hotels, bars and restaurants, and other points of interest (POI). Furthermore, the present invention may include additional detail including non-coastal information such as mountainous terrain, architectural or historical landmarks, and ruins etc.

The present invention enables a visually appealing and intuitive method of displaying information and content without requiring specific search terms as one finds in typical search engines. The intent of the TRIPVIEW system is to promote discovery of new areas of interest in a quick and novel manner. TRIPVIEW will be launched representing digital content for desirable destinations such as Spain, France, Italy, Greece, Turkey, Bahamas, Jamaica, Mexico, Indonesia, Thailand, Philippines, Hawaii. The TRIPVIEW databases of content will grow to cover over 300,00 kilometers and potentially access in excess of 3,000,000 aerial photos, thousands of hours of geotagged video representing thousands of hotels and POIs.

In view of the above, the presently disclosed embodiments and equivalents thereof, facilitate travel planning through the use of a novel, computer- implemented, web-based platform that uses geotagged image and video segment paired information. Specifically, the platform provides a travel-planning friendly user interface (UI) to aid travel planners and travel planning professionals to be able to easily switch between geotagged video and still images taken aerially. Never before has such information ever been taken for the purpose contemplated herein; this being to address a critical need for an improved travel planning tool.

The approach presented involved planning travel arrangements by first identifying a target travel area of interest in relation to a map selected by a travel planner, or by selection or search of a desired destination. A selection, by the travel planner, to a point on the map is next identified and the corresponding aerially taken video corresponding to the point on the map is retrieved. At the user's selection, or otherwise automatically, a routine determines the frame in the video having a closest (or actual) geo-coordinate match to the point on the map.

A further routine causes the video to stream to the matching frame. Once there, the video will begin to play. At the same time, aerially taken pictures having similar or identically sync'd geotag information as those of a particular video frame as the video is streamed, can be retrieved virtually seamlessly in response to a detection by the platform that the travel planner has given a command to switch from video steaming mode to still image mode.

In an exemplary embodiment, as the video frames and or still images play in sequence, the current geolocation of the moving vehicle from where the media content was taken (in terms of geo-location) is displayed graphically on the map visual displayed on a separate portion of the screen. The map information may include a sliding zoom feature.

In another scenario, the map is adapted to include a hyperlink to one or more video streams comprising the video collection associated with a particular location. Each video stream is of predetermined length and may cover the same or different area of travel depending on the extent to which travel planners are likely to explore a fly-over area.

The platform includes a mechanism that facilitates replacing any one video stream without impacting any of the other video streams, as may be necessary, when a new hotel for example, has gone up in the area associated with the updated video stream.

In a preferred embodiment, the aerial video and photography are taken along the coastlines from a helicopter, airship, unmanned aerial vehicle, or the like,

In another aspect, aerially taken images are specially taken photographs using a trained eye.

In another aspect, multiple photographs are shown in image view taken by multiple cameras simultaneously and geotagged to the same frame or set of frames of the corresponding video sequence.

In yet another aspect, the still images include optional tags (hyperlinks) to websites of sponsored hotels, places of interest, promotional info, and/or targeted advertising.

In another aspect, for travel planning purposes, the video streams may be tagged as shared and forwarded to third party. The third party may be provided with a plug-in or other functionality enabling the user to view the video stream as part of a browser with functionality similar to that of the platform, and to also switch to image view as when logged on to the travel planning server. In another approach, the recipient is required to link to the platform where he/she is taken to the travel planning platform directly.

In yet another aspect, the trip planning is performed by a travel agent professional. The travel agent may provide a customer with a single destination view, with multiple alternative destination views to consider, or with a pre-planned package comprised of different destinations. The customer simply clicks on the links where he/she can experience visually a new way by which to capture the surrounding aesthetics of places one would hope to visit, and in an easy to visualize way, quickly grasp from multiple angles, different digital visual content.

In one approach, the images are taken, by a trained photographer, at the same time the video is taken so as to provide a timestamp reference between the two forms of digital content. In another approach, each frame of video is individually geotagged in the same way the still images are geotagged, and the platform includes a mechanism for synchronizing the video data in a database of different destinations to the corresponding still images based on geotag information. Given this latter approach, the images may be taken at the same time, in the same manner, or at a different time and different manner.

In yet another approach, the platform includes same screen accessible links which provide information about an area being currently viewed, such as weather, history, currency, crime, advertising opportunities, local hospitals, popular bars, special hotel or attraction discounts, special package arrangements by local travel agents, and the like.

In yet another scenario, the map information is displayed in either or both 2D and 3D perspective, and the map rotated in sync with the direction of travel of the vehicle from which the video is taken to provide a positional orientation of the vehicle in relation to the map. GPS positioning information may also be provided to record the height/depth of the aerial video recording and to provide a visual of this information in the form of a graphic or by zooming the map portion of the screen in and out of the page as a function of dive, speed and orientation conditions of the aerial recording vehicle.

In another scenario the content is collected, in part using unmanned vehicles, with video and still image content being taken and/or controller remotely by automatic pilot.

Those of skill would also further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Furthermore, functionality of system 100 may be implemented entirely on the client side or any combination of server side and client side implementations, as those with skill in the art would appreciate. Skilled artisans may implement the described functionality in varying ways for each particular application, but such implementation decisions should not be interpreted as causing a departure from the scope of the present disclosure.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. For example, one skilled in the art would appreciate the ability to focus the overall system experience based upon control of one type of data source (i.e. map data, video, text, advertisements, photographs, and sound. Thus, the disclosure is not intended to be limited to the examples and designs described herein but are to be accorded the widest scope consistent with the principles and novel features disclosed herein.

What is claimed is:

1. A computer-implemented method of making travel planning arrangements comprising:
identifying a target travel area of interest in relation to a map selected by a travel planner, or by selection or search of a desired destination by the travel planner;
identifying a selection, by the travel planner, to a point on the map;
retrieving an aerially taken video corresponding to the point on the map;
identifying a frame in the video, other than the beginning of the video, which has a geotag that is a closest match to the point on the map;
launching a video player and playing the video from the point in the video corresponding to the identified frame;
identifying a selection to switch to image mode;
retrieving an aerially taken geotagged image substantially matching the geotag of that video frame in the video playing at the time of the selection to switch to image mode; and
switching to image mode and displaying the aerially taken geotagged image.

2. The method of claim 1, wherein the map includes a sliding zoom feature.

3. The method of claim 1, wherein the map is adapted to include a hyperlink to one or more video streams comprising the video collection associated with a particular location, each video stream being of predetermined length and may cover the same or different area of travel depending on the extent to which travel planners are likely to explore a fly-over area.

4. The method of claim 1, further comprising replacing any one video stream without impacting any of the other video streams.

5. The method of claim 1, wherein the aerial video and images are taken along the coastlines from a helicopter, airship, or unmanned aerial vehicle.

6. The method of claim 1, wherein the aerially taken images include multiple sets of time sequenced images taken from multiple camera sources.

7. The method of claim 1, wherein the aerially taken images include hyperlinks to targeted advertising sources.

8. The method of claim 1, further comprising identifying a request to share an aerially taken image and providing a third party with a link to access the aerially taken image selected for sharing.

9. The method of claim 1, further comprising identifying a request to share a geotagged video segment and providing a third party with a link to access a video browser to view the geotagged video segment selected for sharing.

10. The method of claim 1, further comprising compiling a series of links to geotagged video and image combination streams for multiple travel destinations and creating a vacation package.

11. The method of claim 1, wherein the video player and the map are displayed alongside one another.

12. The method of claim 1, further comprising identifying a selection to provide additional information related to a currently displayed aerially taken geotagged image, retrieving information related to the location based on geotag data, and displaying this information.

13. The method of claim 12, wherein the additional information is to hotels at location.

14. The method of claim 12, wherein the additional information includes information relating to at least one of weather, history, currency, crime, advertising opportunities, local hospitals, popular bars, special hotel or attraction discounts, and special package arrangements.

15. The method of claim 1, further comprising rotating the map in sync with the direction of travel of the vehicle from which the video was taken to provide a positional orientation of the vehicle in relation to the map.

16. A server device including a web-based platform for making travel planning arrangements comprising:
means for identifying a target travel area of interest in relation to a map selected by a travel planner, or by selection or search of a desired destination by the travel planner;
means for identifying a selection, by the travel planner, to a point on the map;
means for retrieving an aerially taken video corresponding to the point on the map;
means for identifying a frame in the video, other than the beginning of the video, which has a geotag that is a closest match to the point on the map;
means for launching a video player and playing the video from the point in the video corresponding to the identified frame;
means for identifying a selection to switch to image mode;
means for retrieving an aerially taken geotagged image substantially matching the geotag of that video frame in the video playing at the time of the selection to switch to image mode; and
means for switching to image mode and displaying the aerially taken geotagged image.

17. The server device of claim 16, further comprising means for replacing any one video stream without impacting any of the other video streams.

18. The server device of claim 16, wherein the aerial video and images are taken along the coastlines from a helicopter, airship, or unmanned aerial vehicle.

19. The server device of claim 16, wherein the aerially taken images include multiple sets of time sequenced images taken from multiple camera sources.

20. The server device of claim 16, wherein the aerially taken images include hyperlinks to targeted advertising sources.
